(19) United States
(12) Patent Application Publication
(10) Pub. No.: US 2025/0159369 A1
(43) Pub. Date: May 15, 2025

(54) OBJECT TRACKING APPARATUS, CONTROL METHOD THEREOF, IMAGING SYSTEM, AND STORAGE MEDIUM

(71) Applicant: CANON KABUSHIKI KAISHA, Tokyo (JP)

(72) Inventor: MOTOYUKI ASANO, Tokyo (JP)

(21) Appl. No.: 18/913,108

(22) Filed: Oct. 11, 2024

(30) Foreign Application Priority Data
Nov. 14, 2023 (JP) 2023-193697

(51) Int. Cl. H04N 25/47; G06V 10/776; G06V 20/40

(52) U.S. Cl. CPC H04N 25/47; G06V 10/776; G06V 20/44

(57) ABSTRACT

An imaging system 10 includes an event detection apparatus 11 and an imaging apparatus 12. The event detection apparatus 11 detects, as an event, that a change in luminance of a pixel performing photoelectric conversion of incident light exceeds a predetermined threshold. The imaging apparatus 12 images an object at a fixed frame rate. A system control unit 13 controls the event detection apparatus 11 and the imaging apparatus 12. An event detection control unit 14 performs control for setting event detection conditions of the event detection apparatus 11 based on the imaging state of the imaging apparatus 12. A data processing unit 15 generates image data from each output signal of the event detection apparatus 11 and the imaging apparatus 12. The tracking control unit 16 performs detection and tracking control of the object by using the image data generated by the data processing unit 15.

### BACKGROUND OF THE INVENTION

### Field of the Invention

The present invention relates to an image processing technology and the like using an imaging apparatus and an event detection apparatus.

### Description of the Related Art

An imaging element mounted on an imaging apparatus includes an asynchronous sensor and a synchronous sensor. An event-driven vision sensor (hereinafter, referred to as an “event-based sensor”) is an asynchronous sensor that detects a change in brightness of each pixel as an event and asynchronously outputs an event signal including a time at which the event occurs and a pixel position. Additionally, a synchronous sensor (hereinafter, also referred to as a “frame-based sensor”) performs imaging in synchronization with a vertical synchronizing signal, and outputs a frame data that is image data of one frame (screen) in a cycle of the vertical synchronizing signal.

The event-based sensor can detect, for example, that the amount of change in luminance exceeds a predetermined threshold as an event, and thus has advantages of low latency and low power consumption as compared to a frame-based sensor that performs all-pixel readout. Additionally, the pixel of the event-based sensor logarithmically converts the luminance of incident light into a voltage. Even in a low luminance state, a slight luminance difference can be detected, and in a high luminance state, conversely, when a large luminance difference appears, the sensor reacts, thereby preventing saturation of an event signal and obtaining a wide dynamic range. Furthermore, the time resolution of the event information is as high as several nanoseconds (ns) to several microseconds (u s), and there is no image blur (object blur) with respect to a moving object.

An imaging system using the characteristics of each of the above sensors has been proposed. Japanese Patent Laid-Open No. 2020-161992 discloses a configuration in which, in an imaging system including an imaging apparatus and an event detection apparatus, a threshold of the event detection apparatus is dynamically changed based on external information. Additionally, Japanese Patent Application Laid-Open No. 2020-136958 discloses a configuration in which, in a sensor capable of simultaneously outputting a gradation signal and event data, the detection range of an event is designated according to an object recognition result of a gradation image based on the gradation signal.

An imaging apparatus having an object tracking function needs to capture an image while tracking a specific object. Under severe exposure conditions or in the case of a high-speed moving object, the imaging apparatus may lose sight of the object. The severe exposure condition is a condition corresponding to a scene with a rapid change in brightness, a scene with low contrast (saturation, low illuminance), and the like. Here, it is assumed that the event detection apparatus is used in an auxiliary manner. If the event detection apparatus is frequently operated together with the imaging apparatus, the processing load and power consumption of the entire image capturing system becomes large.

### SUMMARY OF THE INVENTION

An object tracking apparatus according to an embodiment of the present invention comprises: an acquisition unit configured to acquire an output of an event detection apparatus that detects an event from a change in luminance of a pixel and an output of an imaging apparatus that images an object at a predetermined frame rate; a first control unit configured to control the event detection apparatus and the imaging apparatus; a second control unit configured to control a detection condition for the event detection apparatus to detect an event; a data processing unit configured to generate image data from an output of the imaging apparatus and an output of the event detection apparatus; and a third control unit configured to perform detection and tracking control of an object by using the image data generated by the data processing unit, wherein the second control unit performs control for setting a detection condition of the event detection apparatus according to an imaging state of the imaging apparatus.

Further features of the present invention will become apparent from the following description of embodiments with reference to the attached drawings.

### BRIEF DESCRIPTION OF THE DRAWINGS

FIG. 1 is a block diagram illustrating a configuration example of an imaging system according to the embodiment.

FIG. 2 is a diagram of an event generated by an event detection apparatus.

FIG. 3 is a diagram illustrating an example of a captured image and an event image.

FIGS. 4A to 4F are diagrams illustrating a problem to be solved by the present disclosure.

FIG. 5 is a flowchart illustrating an example of a process for controlling the imaging system.

FIG. 6 is a diagram that explains an event detection threshold according to contrast.

FIGS. 7A to 7D are diagrams illustrating examples of a captured image and an event image when an event detection condition is changed.

FIGS. 8A to 8F are diagrams that explain settings of an event detection condition according to a moving speed of an object.

### DESCRIPTION OF THE EMBODIMENTS

Hereinafter, with reference to the accompanying drawings, favorable modes of the present invention will be described by using the Embodiments. In each diagram, the same reference signs are applied to the same members or elements, and duplicate description will be omitted or simplified.

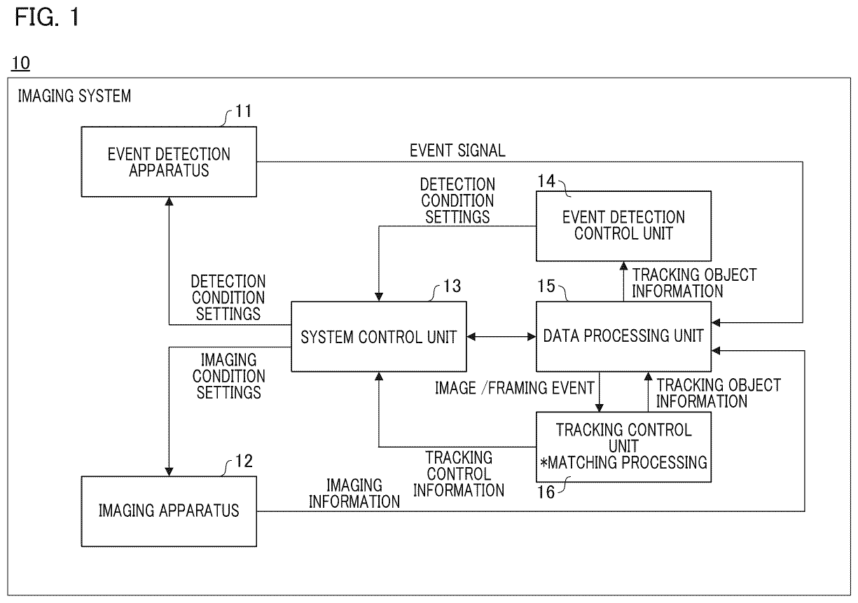

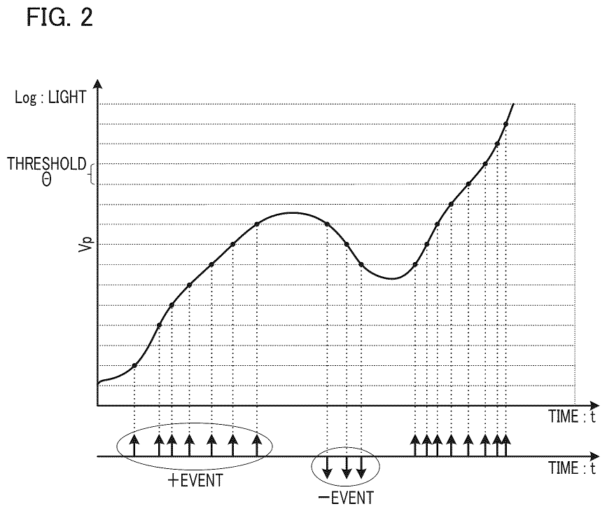

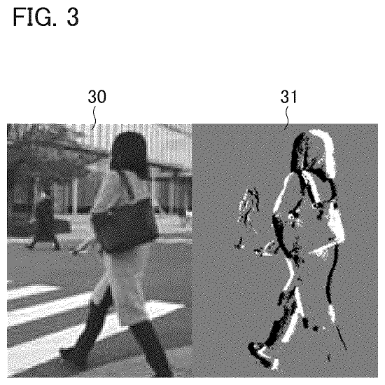

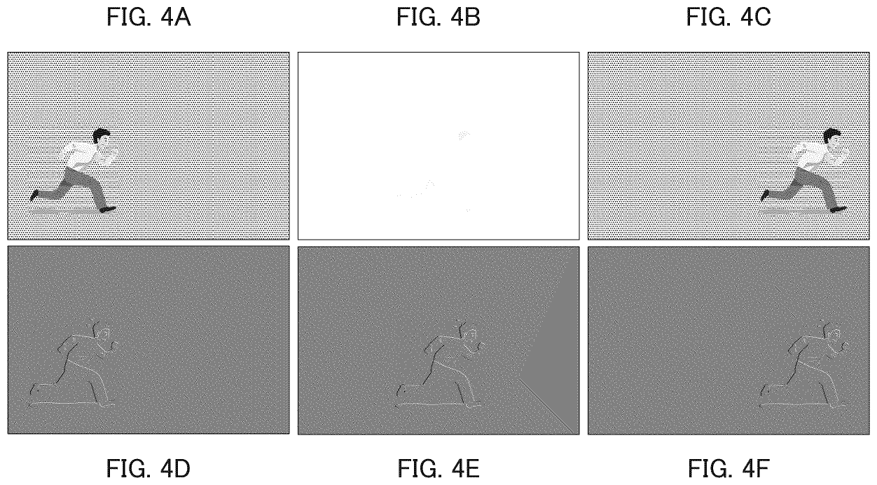

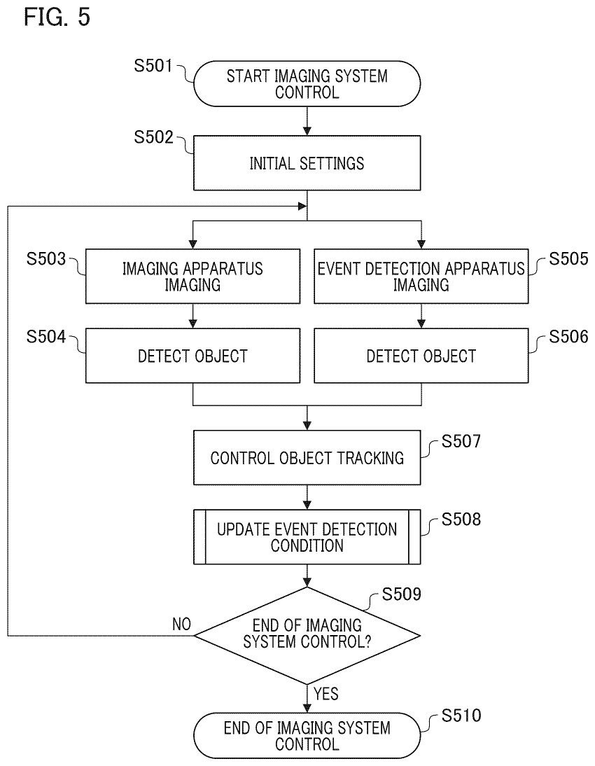

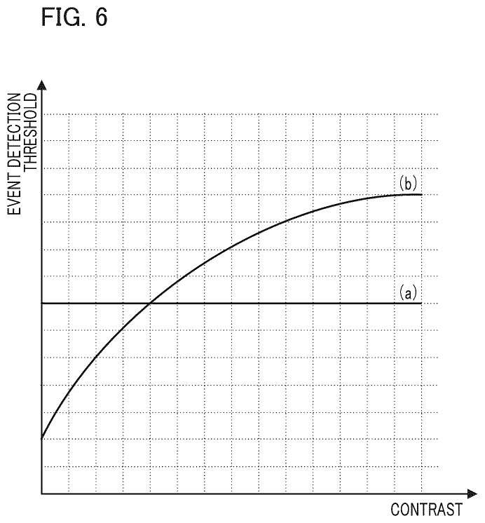

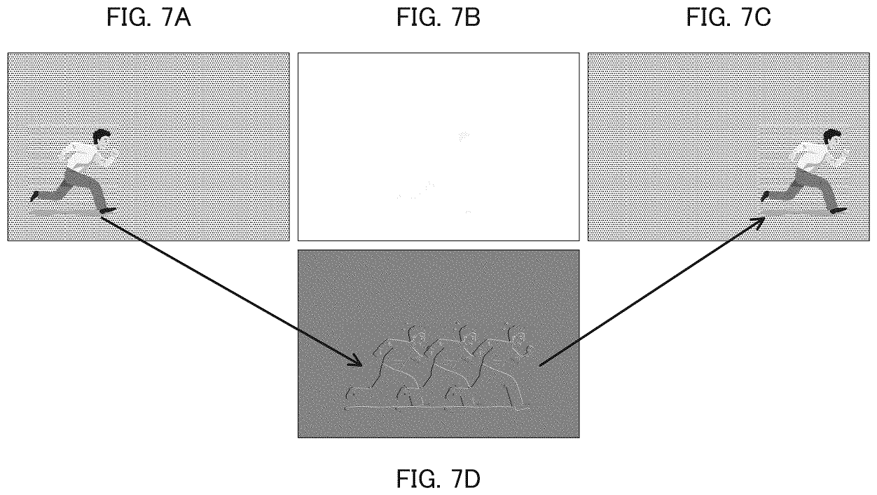

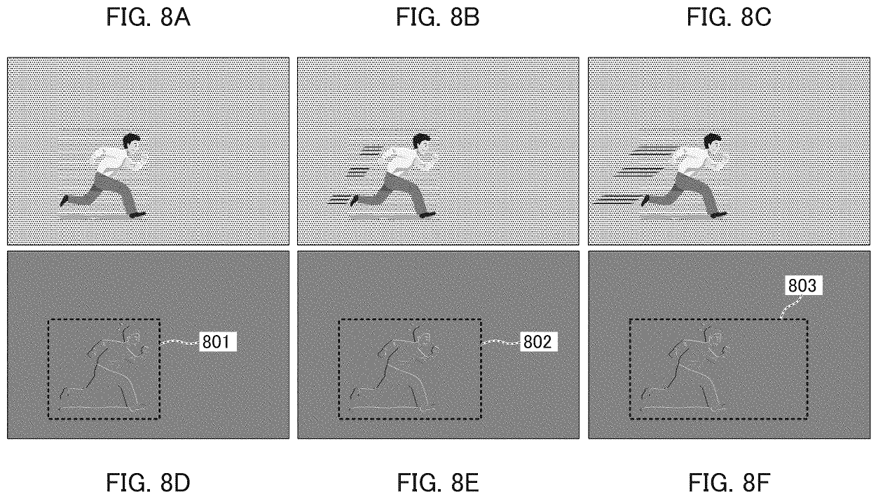

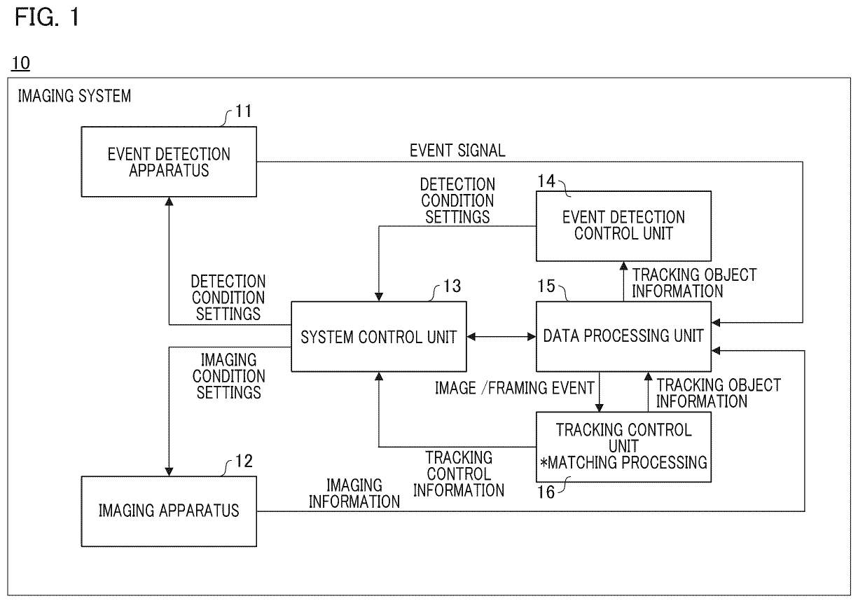

FIG. 1 is a block diagram illustrating a configuration example of an imaging system 10. The imaging system 10 includes an event detection apparatus 11 and an imaging apparatus 12. The imaging element of the event detection apparatus 11 is an event-based sensor. An imaging element of the imaging apparatus 12 is a frame-based sensor.

The event detection apparatus 11 detects a luminance change in the imaging range of the event-based sensor, and asynchronously outputs an event signal. As an example of the asynchronous event-based sensor, there is a configuration in which a plurality of pixels is arranged in a two-dimensional array, a trigger signal is generated when a voltage signal that is a logarithm of the intensity of light incident to each pixel exceeds a threshold, and an event signal is output. The event signal is a signal associated with an event, and includes, for example, information on a time at which the event has been detected and a pixel position at which the event has occurred. The time at which the event has been detected may be measured based on the time of the internal clock of the event detection apparatus 11 (event detection apparatus time) or may be reset as necessary. Additionally, the event signal may include one or more pieces of information to be described below.
Information indicating a luminance change value.
Information indicating a sign (positive or negative) of the luminance change value.

The event detection apparatus 11 asynchronously outputs an event signal only when a luminance change of an image occurs. Note that “asynchronously output” means that output is performed independently in terms of time on a pixel-by-pixel basis without synchronization among all pixels.

The imaging apparatus 12 captures an image at a fixed frame rate in synchronization with the vertical synchronizing signal, and outputs a frame-format image data. Examples of the synchronous frame-based sensor include a complementary metal oxide semiconductor (CMOS) image sensor and a charge-coupled device (CCD) image sensor.

A system control unit 13 comprehensively controls the imaging system 10. The system control unit 13 includes a CPU (Central Processing Unit) and the like, and performs control of the entire system and various calculations.

A data processing unit 15 acquires an event signal from the event detection apparatus 11 and image data including imaging information from the imaging apparatus 12. Additionally, the data processing unit 15 processes the event signal and the image data and outputs the processed data to an event detection control unit 14 and a tracking control unit 16. The data processing unit 15 acquires tracking object information, which is a tracking result of the object, from the tracking control unit 16.

The event detection control unit 14 calculates a condition (hereinafter, referred to as a “detection condition”) for the event detection apparatus 11 to detect an event based on the tracking object information that has been acquired from the data processing unit 15, and instructs the system control unit 13 to set or change the detection condition.

The tracking control unit 16 acquires image data and an event signal from the data processing unit 15, or acquires data of a framed image (hereinafter, referred to as an “event image”) generated from the event signal. The tracking control unit 16 performs object detection processing and tracking control based on the acquired information. For example, the tracking control unit 16 identifies whether or not the object is a person, animals, or an object (a vehicle and the like) by performing pattern matching processing, and detects the position of the face or the position of the pupil when the object is a person. Note that the identification processing is not limited to the pattern matching processing, and may be executed by another method. The tracking control unit 16 outputs control information of the tracking object (tracking control information) to the system control unit 13. Object tracking is performed by a known method, focusing, brightness, color, and the like are appropriately adjusted with respect to the tracked object, and image capture is performed.

The event detection apparatus 11, the imaging apparatus 12, the control units 13, 14, and 16, and the data processing unit 15 have storage regions necessary for control and processing, and read out and write data at necessary timings.

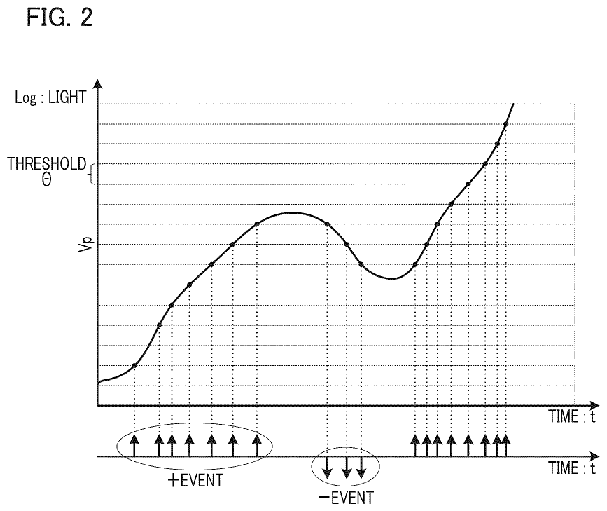

An event generated by the event detection apparatus 11 will be explained with reference to FIG. 2. In the graph as shown in the upper part of FIG. 2, the horizontal axis represents a time axis t, and the vertical axis represents a voltage (Vp) that is a logarithmic function of the intensity of incident light. A plurality of dotted lines as shown in the horizontal direction from the vertical axis represent a threshold (denoted by Θ) of the voltage signal when the event detection apparatus 11 generates a trigger signal. That is, the vertical axis is set in units of the voltage change amount Θ. The lower diagram of FIG. 2 shows a state of event detection, and the horizontal axis represents a time axis t. When the voltage Vp increases beyond the threshold Θ, the upward arrow indicates “+event”, and when the voltage Vp decreases beyond the threshold Θ, the downward arrow indicates “−event”.

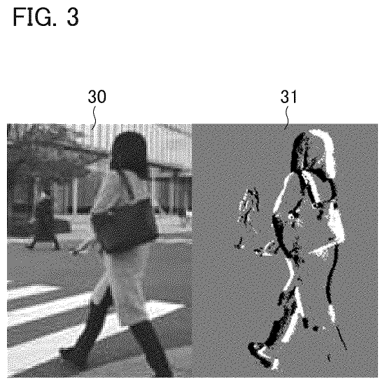

An example of the event image will be explained with reference to FIG. 3. FIG. 3 shows an example of output from the event detection apparatus 11. An image 30 is an image output by an image sensor (frame-based sensor), and details of a static background portion in addition to an object within an imaging range are shown. An image 31 is an event image, which is an image generated as one frame by a plurality of events occurring during a time period equivalent to the time period during which the image sensor has accumulated light to generate the image 30.

In the image 31 of FIG. 3, a −event corresponds to a black pixel and a +event corresponds to a white pixel. The gray regions correspond to pixels where no event has occurred. An outline portion of a region in which an object person moves from the right to the left of the screen corresponds to black pixels or white pixels, and the movement of the person can be recognized by detecting a luminance change. In contrast, a pedestrian crossing and the like, which are static background portions, have no luminance change or have a small luminance change, and thus, are gray regions. The amount of data included in the image 31 per predetermined period of time is much smaller than that of the image 30, and because post-processing for tracking or recognizing a change in a scene is easy, efficient processing is possible. Although, in the example of FIG. 3, a representation method using black pixels, white pixels, and a gray region is shown, the present invention is not limited to this example, and other colors may be used, or an event image generated by changing a pixel value according to an intensity level of a luminance change may be used.

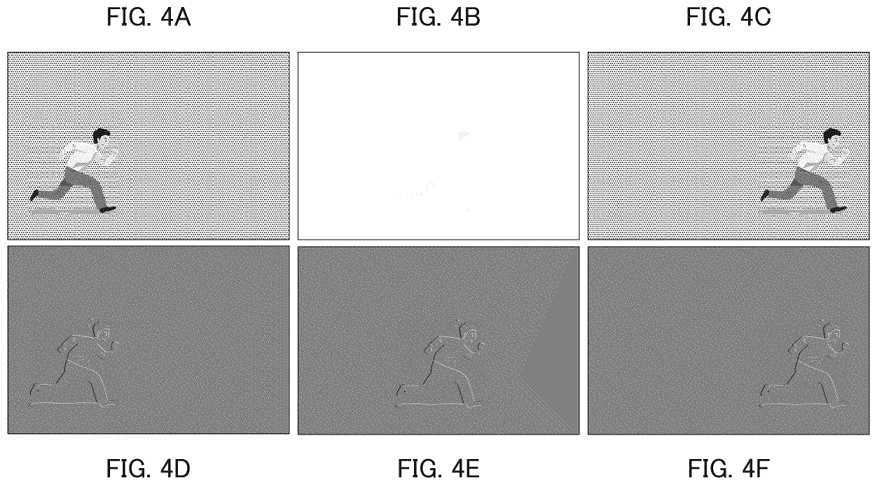

Next, a problem to be solved by the present disclosure will be explained with reference to FIG. 4. FIGS. 4A to 4C illustrate captured images in which the imaging apparatus 12 captures an object, and are a plurality of images arranged in time series. The moving direction of the object to be tracked (tracking object) is from the left to the right of the screen. FIG. 4A shows an image in which the object is shown on the left side, FIG. 4B shows an image in which the object is shown in the center, and FIG. 4C shows an image in which the object is shown on the right side. Each of FIGS. 4D and 4E is event image corresponding to each of FIGS. 4A to 4C, and generated by the event detection apparatus 11.

The object tracking operation starts from the state of FIG. 4A. In FIG. 4B, the imaging state is close to saturation (low contrast state), and there is a possibility that the imaging apparatus 12 loses sight of the tracking object. Control for continuously tracking an object detected from the event image shown in FIG. 4E is performed. In FIG. 4C, it is assumed that the imaging apparatus 12 takes over the tracking of the object detected by the event detection apparatus 11. At this time, if the event detection apparatus 11 is performing event detection, an event always occurs. Therefore, there is a possibility that the processing load and power consumption of the entire imaging system 10 increase. In the present disclosure, a configuration and the like for solving this problem will be explained.

### First Embodiment

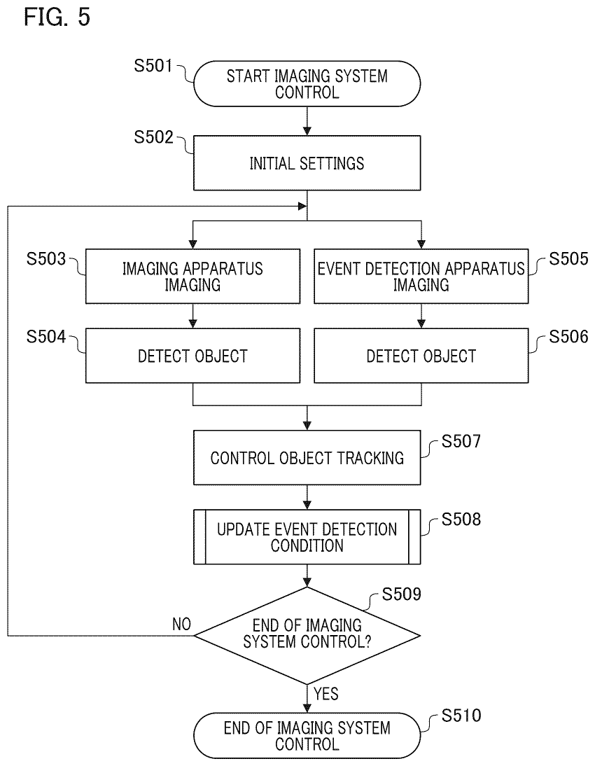

The control performed by the imaging system 10 of the present embodiment will be explained with reference to FIG. 5. The following processes are realized according to a predetermined program executed by the system control unit 13. In S501, the system control unit 13 starts processing related to imaging system control, and the process proceeds to the process of S502.

In S502, the system control unit 13 performs initialization processing. The system control unit 13 sets imaging conditions for the imaging apparatus 12 in response to a request from the data processing unit 15 or the tracking control unit 16. The imaging conditions to be set are determined by the system control unit 13 based on the imaging information from the data processing unit 15 or the tracking object information by the tracking control unit 16. However, at the start of the imaging system control, since there is no imaging information or tracking object information, the imaging conditions stored in the system control unit 13 are set. Subsequently, the system control unit 13 sets an event detection condition in the event detection apparatus 11 in response to a request from the event detection control unit 14. The event detection condition to be set is determined by the event detection control unit 14 based on the imaging information acquired from the data processing unit 15 and the tracking object information acquired from the tracking control unit 16 via the data processing unit 15. However, at the start of the imaging system control, since there is no imaging information or tracking object information, the event detection condition stored in the event detection control unit 14 is set. For example, a detection condition and the like associated with the imaging condition set in the imaging apparatus 12 is set.

After S502, the first processing (S503 and S504) performed by the imaging apparatus 12 and the second processing (S505 and S506) performed by the event detection apparatus 11 are executed (parallel processing) in parallel. In S503, the imaging apparatus 12 performs imaging processing, and a captured image is generated. In the next S504, the imaging apparatus 12 performs the object detection processing on the captured image generated in the S503, and the first object detection information is acquired.

In S505, the event detection apparatus 11 performs event detection processing, and a framed event image corresponding to the detected event is generated. In the next S506, the event detection apparatus 11 performs the object detection processing on the framed event image generated in S505, and second object detection information is acquired.

After S504 or S506, the process proceeds to S507. In the imaging apparatus 12, the process shifts from S504 to S507 for each imaging cycle, and in the event detection apparatus 11, the process shifts from S506 to S507 for each framing cycle of the event.

In S507, the tracking control unit 16 performs control including determination processing of the tracking object. Based on the first object detection information acquired in S504 and the second object detection information acquired in S506, it is determined which object should be set as the main object and which object should be set as the tracking object. Additionally, the tracking object information, which is the determination result, is stored in a storage region in the tracking control unit 16. Next, the process proceeds to S508.

In S508, the event detection control unit 14 updates an event detection condition for detecting an event by the event detection apparatus 11 based on the tracking object information determined in S507. According to the updated event detection condition, the system control unit 13 sets the condition for the event detection apparatus 11. The process of determining the event detection condition will be described in detail below. Next, the process proceeds to S509.

In S509, the system control unit 13 determines whether to end the control of the imaging system 10. For example, the system control unit 13 determines whether or not a user operation of an operation member (a power on/off switch and the like) provided in the imaging system 10 has been performed. In a case where the operation member is not operated (power-on state), the process shifts to S503 and S505, and the imaging processing performed by the imaging apparatus 12 and the event detection apparatus 11 is continued. In addition, in a case where an operation for ending the imaging system control is performed (power-off operation), in S510, the system control unit 13 ends the control of the imaging system 10.

Next, the object tracking control illustrated in S507 of FIG. 5 will be described in detail. As described above, the imaging processing performed by the imaging apparatus 12 and the imaging processing performed by the event detection apparatus 11 are executed in parallel, and the object detection processing is performed after the imaging. Outputs from the imaging apparatus 12 and the event detection apparatus 11 are asynchronously transferred to the data processing unit 15. The data processing unit 15 performs data processing according to the output from each device.

The tracking control unit 16 acquires the data of the captured image generated by the imaging apparatus 12 and the data of the event image generated by the event detection apparatus 11, which have been processed by the data processing unit 15, and performs object detection processing and object determination processing for object tracking. These processing are performed on the input captured image and event image according to the input timing. Additionally, the tracking control unit 16 performs processing for holding data indicating the result of object detection based on the captured image and the event image in a temporary storage device and the like. The following three cases will be explained.

(1) The case where object detection is performed based on both the captured image and the event image.
(2) The case where the object detection is performed based on only the event image.
(3) The case where object detection is performed based only on a captured image.

First, (1) will be explained. Although it is assumed that the object that has been detected by the imaging apparatus 12 is prioritized, for example, a state in which it is difficult to detect the object including a low contrast state is assumed. Accordingly, the tracking control unit 16 calculates an index including the reliability of the detected object, and uses the index to determine which object is to be tracked. For example, in a case where the reliability of the object detection based on the captured image and the reliability of the object detection based on the event image can be acquired, the tracking control unit 16 determines which of the results of object detection for the images is to be used according to each of the reliabilities of the object detection. The result of object detection in which the reliability is higher is selected.

Next, (2) will be explained. In an actual operation, the cycle of the image signals generated from the imaging apparatus 12 and the cycle of the image signals generated from the event detection apparatus 11 are different. For example, it is assumed that an output frequency of the event detection apparatus 11 is higher than that of the imaging apparatus 12. In a state where the imaging apparatus 12 is in imaging operation and the object detection processing of the event detector 11 is completed, the result of object detection of the event image and the result of object detection of the immediately preceding captured image are held in a storage unit. In this case, the tracking control unit 16 determines the tracking object by comparing the reliability of the object detection based on the event image and the reliability of the object detection based on the immediately preceding captured image. In a case where the reliability of the object detection based on the event image is higher than the reliability of the object detection based on the immediately preceding captured image, the object detected from the event image is selected and determined to be the tracking target. Additionally, in a case where the reliability of the object detection based on the immediately preceding captured image is higher than the reliability of the object detection based on the event image, the object detected from the captured image is continuously determined to be the tracking target.

Next, (3) will be explained. In this case, a pattern opposite to (2) is assumed. In a state in which the object detection processing in the imaging apparatus 12 is completed, the result of object detection based on the captured image and the result of object detection based on the immediately preceding event image are held in the storage unit. In this case, the tracking control unit 16 determines the tracking object by comparing the reliability of the object detection based on the captured image and a predetermined threshold. In a case where the reliability of object detection based on the captured image exceeds a predetermined threshold, the object detected from the captured image is determined to be the tracking target. In a case where the reliability of the object detection based on the captured image is equal to or less than the predetermined threshold, the tracking control unit 16 compares the reliability of the object detection based on the captured image and the reliability of the object detection based on the held event image. In a case where the reliability of the object detection based on the captured image is higher than the reliability of the object detection based on the event image, the object detected from the captured image is determined to be the tracking target. Additionally, in a case where the reliability of the object detection based on the event image is higher than the reliability of the object detection based on the captured image, the object detected from the event image is determined to be the tracking target. Information on the object determined to be the tracking target (tracking object information) is held in the temporary storage unit of the tracking control unit 16.

Next, a process of determining an event detection condition of the event detection apparatus 11 based on the imaging state of the imaging apparatus 12 and the tracking object information determined by the tracking control unit 16 will be explained. The event detection apparatus 11 sets a region in which event detection is performed (event detection region) based on the tracking object information that has been determined by the tracking control unit 16. The event detection region in the image is one of the event detection conditions, and it is possible to reduce the processing load and the power consumption of the entire imaging system 10 by limiting the detection region based on the tracking object information and reducing the generation frequency of the event.

A process of changing the event detection condition according to the imaging state of the imaging apparatus 12 will be explained. The threshold for event detection is set as a fixed value or a variable value. In the example as explained with reference to FIG. 2, the threshold Θ is set to a uniform value. In imaging in a low illuminance state, a saturation state, and the like in which it is difficult to track an object, there are many cases in which the contrast is low even for the same object. In this case, similar to the imaging apparatus 12, there is a possibility that the object cannot be detected from the event image generated by the event detection apparatus 11. Accordingly, the event detection conditions are changed so that the event detection apparatus 11 is set to a state in which an event is likely to be generated and an event image in which an object can be detected can be generated.

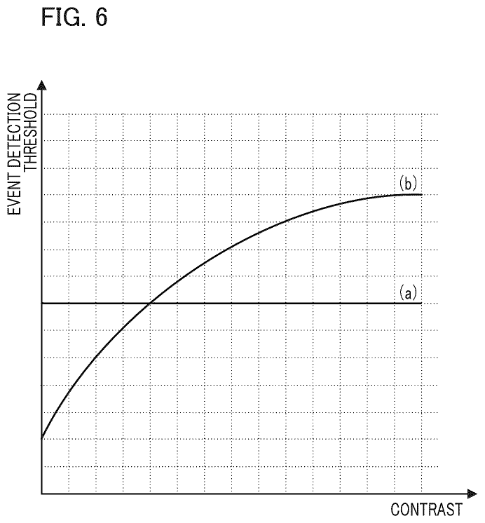

FIG. 6 is a graph for explaining a process in which the event detection control unit 14 changes the event detection threshold according to the contrast of the captured image. The horizontal axis represents the contrast of the captured image, and the vertical axis represents the event detection threshold Q. In the graph line (a), the event detection threshold Θ is a constant value regardless of the contrast of the captured image. In the graph line (b), as the contrast decreases, the event detection threshold Θ decreases, and as the contrast increases, the event detection threshold Θ increases. When the event detection threshold Θ is set to be small, it is possible to detect an event even in a case where a change for each pixel is small under a low contrast in a low illuminance state or a saturation state. Additionally, since the object detection and the object tracking performed by the imaging apparatus 12 sufficiently function under a high contrast including an appropriate exposure state, an event detection condition in which an event does not occur as much as possible is required. Therefore, control is performed to reduce the occurrence frequency of events by setting the event detection threshold Θ to a large value.

As described above, in a state where object detection is performed based on the captured image acquired by the imaging apparatus 12 and the object can be tracked, event detection conditions are set in such a manner that the generation frequency of events in the event detection apparatus 11 becomes low. In an imaging condition in which it is difficult for the imaging apparatus 12 to track an object, an event detection condition in which an event is likely to be generated is set in the event detection apparatus 11. Thus, it is possible to generate an event image at a necessary timing and continuously perform object tracking.

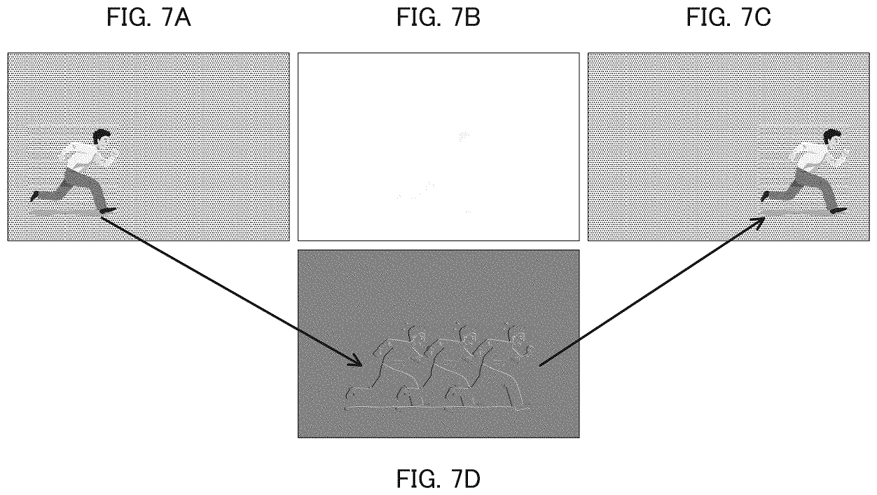

FIG. 7A to 7C illustrate output examples of the imaging apparatus when the event detection condition is changed, and FIG. 7D illustrates an output example of the event detection apparatus when the event detection condition is changed. Similar to FIGS. 4A to 4C, FIGS. 7A to 7C illustrate a plurality of captured images arranged in time series with respect to an object captured by the imaging apparatus 12. FIG. 7D schematically illustrates an event image corresponding to FIG. 7B, which is an image generated by the event detection apparatus 11. In FIG. 7D, it is assumed that the captured images of FIG. 7B are a plurality of images in the low contrast state. At the timing when the imaging state changes from FIG. 7A to FIG. 7B and from FIG. 7B to FIG. 7C, the event detection apparatus 11 performs event detection to generate an event image after object detection is performed.

In the present embodiment, control that dynamically changes the event detection threshold of the event detection apparatus 11 according to the contrast of the captured image is performed. In addition, there is a method of changing the event detection threshold based on the brightness of a captured image and exposure conditions (an aperture value, a shutter speed, a sensor gain, and the like) of the imaging apparatus 12. Additionally, there is a method of changing the event detection threshold according to an inter-frame difference in luminance of an image region including the tracking object in the captured image or an inter-frame difference in luminance of the entire captured image.

According to the present embodiment, event detection conditions are dynamically changed based on object information recognized based on a captured image, so that even when the exposure conditions of the imaging apparatus are severe, the event can be detected by the event detection apparatus, and the object can be continuously tracked.

### Second Embodiment

Next, the second embodiment will be explained. In the present embodiment, the event detection condition is dynamically set and changed according to a moving direction and a moving speed of the tracking object. For example, in controlling the event detection condition, the event detection control unit 14 adaptively sets the size or shape of the event detection region in the captured image. Thus, it is possible to continuously track the object even in a situation in which the object tracking by the image capturing apparatus is difficult. Note that, in the present embodiment, the explanation of the same matters as those in the first embodiment will be omitted, and differences from the first embodiment will be explained. Although the process of the present embodiment is similar to the process of FIG. 5 that has been explained in the first embodiment, the process of S508 (event detection condition update) is different, so the contents of this process will be explained in detail.

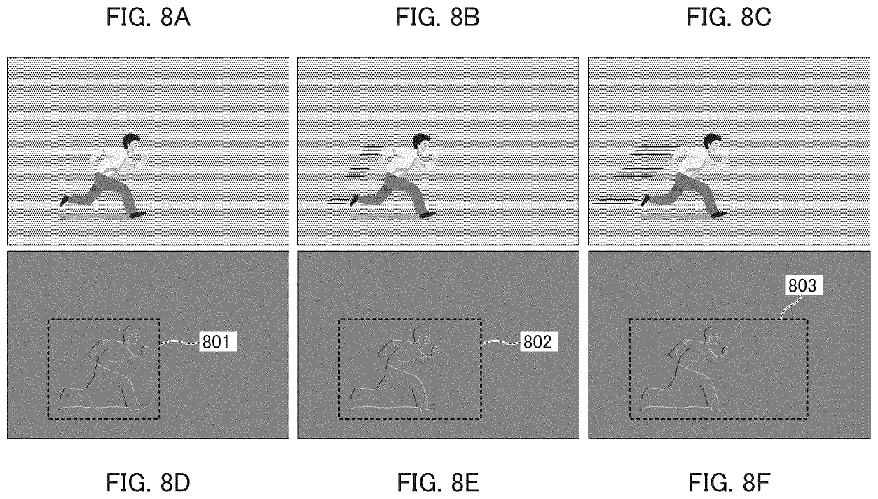

With reference to FIG. 8, a process of dynamically changing the event detection condition of the event detection apparatus 11 according to a moving speed of the tracking object will be explained. FIGS. 8A to 8C illustrate examples of captured images generated by the imaging apparatus 12. The moving direction of the tracking object is from the left to the right on the screen. FIGS. 8A to 8C illustrate a state in which the moving speed of the object becomes large. FIGS. 8D to 8F are event images respectively corresponding to FIG. 8A to 8C, and the event images are generated by the event detection apparatus 11. Similar to FIGS. 8A to 8C, the moving speed of the tracking object increases from FIGS. 8D to 8F. Rectangular dotted-line frames 801 to 803 in FIGS. 8D to 8F represent the boundary of the event detection region in the image and have a relation of “the size of the dotted-line frame 801< the size of the dotted-line frame 802< the size of the dotted-line frame 803”.

Although, in the first embodiment, the method of setting the event detection region based on the tracking object information determined by the tracking control unit 16 has been explained, the moving speed of the object is not taken into consideration. For example, if the moving speed of the tracking object is high, it is necessary to set the event detection region by assuming the moving range of the object.

FIGS. 8A and 8D illustrate a case where the moving speed of the object is relatively low. In this case, as shown by the dotted line frame 801 in FIG. 8D, the event detection region can be limited to only the periphery of the tracking object (the size of the event detection region in the moving direction is small). Additionally, since a difference between pixels is unlikely to occur, the generation frequency an event is low. Accordingly, if the number of events is small in a case where an event image is generated, there is a possibility that an object image that can be detected by the tracking control unit 16 in the subsequent stage cannot be acquired. Accordingly, in a case where the moving speed of the object is smaller than the threshold, the data processing unit 15 performs the control for lengthening the framing cycle for generating the event image. Thus, it is possible to generate an object image that can be detected by the tracking control unit 16. In contrast, if it is not desired to extremely lengthen the framing cycle for generating an event image by the event detection apparatus 11, the event detection threshold may be set to be small so that a slight change in pixel output can be detected.

FIGS. 8C and 8F show a case where the moving speed of the object is relatively high. In this case, as shown by a dotted line frame 803 in FIG. 8F, the event detection region is set in consideration of the moving speed in addition to the periphery of the tracking object (the size of the event detection region in the moving direction is large). Although it is also possible to set the entire region as the event detection region in consideration of the size and the moving direction of the object images in the captured image, as described above, if the event detection region is enlarged, the generation frequency of events becomes high, which may increase the processing load of the entire imaging system 10. Therefore, it is desirable to set a minimum event detection region in which the tracking object is not lost. As to how large the event detection region is set according to the moving speed of the object, for example, there is a method of using reference table data for setting held by the imaging system 10. Additionally, there is a method of estimating the next movement position based on the moving speed of the object and setting a region including the movement position as the event detection region.

If the moving speed of the object is high, a difference between pixels is likely to occur, and the generation frequency of an event increases. Therefore, in a case where the event detection apparatus 11 generates an event image, if the number of events is extremely large, there is a possibility that an object image that can be detected by the tracking control unit 16 in the subsequent stage cannot be acquired. For example, the object image may be crushed. In a case where the moving speed of the object is higher than the threshold, the data processing unit 15 performs the control for shortening the framing cycle for generating the event image. Thus, it is possible to generate an object image that can be detected by the tracking control unit 16. In contrast, there is also a case where it is not desired to extremely shorten the framing period for generating an event image by the event detection apparatus 11 (a case where the processing load becomes high, and the like). In this case, the event detection threshold may be increased so that an event can be detected in a case where the amount of change in the pixel output is equal to or larger than a predetermined threshold.

In the present embodiment, the event detection region can be set according to a moving speed (speed and direction) of the tracking object, and the framing cycle and the event detection cycle can be determined based on the processing load and the power consumption of the imaging system 10. It is possible to continuously track the object by dynamically setting the event detection condition of the event detection apparatus according to the moving speed of the tracking object based on the captured image acquired by the imaging device. Additionally, the imaging system 10 can set or change the event detection region according to the moving direction of the tracking object. Additionally, the event detection condition may be dynamically changed according to the relative moving speed between the imaging system 10 and the object, instead of the moving speed of the tracking object.

According to the embodiments, it is possible to continuously perform object tracking under severe exposure conditions such as a scene with a rapid change in brightness and a low contrast scene, or tracking control according to the moving speed and the moving direction of the object. It is possible to perform object tracking control while suppressing the processing load and power consumption of the imaging system by setting or changing the event detection condition of the event detection apparatus based on the imaging state of the imaging apparatus.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the object tracking apparatus and the like through a network or various storage media. Then, a computer (or a CPU, an MPU, or the like) of the object tracking apparatus and the like may be configured to read and execute the program. In such a case, the program and the storage medium storing the program configure the present invention.

In addition, the present invention includes those realized by using at least one processor or circuit configured to perform functions of the embodiments explained above. For example, a plurality of processors may be used for distribution processing to perform functions of the embodiments explained above.

This application claims the benefit of priority from Japanese Patent Application No. 2023-193697, filed on Nov. 14, 2023, which is hereby incorporated by reference herein in its entirety.

What is claimed is:

1. An object tracking apparatus comprising:
at least one processor or circuit configured to function as:
an acquisition unit configured to acquire an output of an event detection apparatus that detects an event based on a change in luminance of a pixel and an output of an imaging apparatus that images an object at a predetermined frame rate;
a first control unit configured to control the event detection apparatus and the imaging apparatus;
a second control unit configured to control a detection condition for the event detection apparatus to detect an event;
a data processing unit configured to generate image data from an output of the imaging apparatus and an output of the event detection apparatus; and
a third control unit configured to perform detection and tracking control of an object by using the image data generated by the data processing unit,
wherein the second control unit performs control for setting a detection condition of the event detection apparatus according to an imaging state of the imaging apparatus.

2. The object tracking apparatus according to claim 1, wherein the second control unit performs control for setting a detection condition of the event detection apparatus by determining brightness or contrast of a captured image acquired by the imaging apparatus or a detection result of an object.

3. The object tracking apparatus according to claim 1, wherein the second control unit acquires information on a tracking object determined by the third control unit and performs control for setting a detection region of an event in an image generated by the event detection apparatus.

4. The object tracking apparatus according to claim 1, wherein the second control unit performs control for changing a detection threshold of an event in the event detection apparatus.

5. The object tracking apparatus according to claim 1, wherein the third control unit calculates a reliability of an object detection result based on a captured image acquired by the imaging apparatus and a reliability of an object detection result based on an image acquired by the event detection apparatus, and performs tracking control by using an object detection result in which the reliability is higher.

6. The object tracking apparatus according to claim 1, wherein the second control unit performs control for changing a detection region of an event in an image acquired by the event detection apparatus according to a moving speed or a moving direction of a tracking object determined by the third control unit.

7. The object tracking apparatus according to claim 1, wherein the data processing unit changes a framing cycle for generating a framed image from an output of the event detection apparatus according to a moving speed of an object detected by the third control unit.

8. The object tracking apparatus according to claim 1, wherein the second control unit performs control for changing a size or a shape of a detection region of an event in an image generated by the event detection apparatus, in the control of the detection condition.

9. The object tracking apparatus according to claim 1, wherein the event detection apparatus detects, as the event, a case where a signal based on intensity of light incident to an imaging element of the event detection apparatus increases exceeding a threshold or a case where the signal decreases below the threshold.

10. An imaging system comprising:
an event detection apparatus that has an asynchronous imaging element and detects an event based on a change in luminance of a pixel;
an imaging apparatus that has a synchronous imaging element and captures an image of an object at a predetermined frame rate; and
at least one processor or circuit configured to function as:
an acquisition unit configured to acquire an output of the event detection apparatus and an output of the imaging apparatus;
a first control unit configured to control the event detection apparatus and the imaging apparatus;
a second control unit configured to control a detection condition for the event detection apparatus to detect an event;
a data processing unit configured to generate image data from an output of the imaging apparatus and an output of the event detection apparatus; and
a third control unit configured to perform object detection and tracking control by using image data generated by the data processing unit,
wherein the second control unit performs control for setting a detection condition of the event detection apparatus according to an imaging state of the imaging apparatus.

11. The imaging system according to claim 10, wherein the second control unit performs control for setting a detection condition of the event detection apparatus according to a moving speed of a tracking object or a relative moving speed between the imaging system and the tracking object.

12. A control method of an object tracking apparatus comprising:
controlling an event detection apparatus and an imaging apparatus based on an output of the event detection apparatus for detecting an event based on a change in luminance of a pixel and an output of an imaging apparatus that images an object at a predetermined frame rate;
performing detection and tracking control of an object based on image data generated from an output of the imaging apparatus and an output of the event detection apparatus; and
setting a detection condition for detecting the event in the event detection apparatus according to an imaging state of the imaging apparatus.

13. A non-transitory computer-readable storage medium configured to store a computer program comprising instructions for executing following processes:
controlling an event detection apparatus and an imaging apparatus based on an output of the event detection apparatus for detecting an event based on a change in luminance of a pixel and an output of the imaging apparatus for imaging an object at a predetermined frame rate;
performing detection and tracking control of an object based on image data generated from an output of the imaging apparatus and an output of the event detection apparatus; and
setting a detection condition for detecting the event in the event detection apparatus according to an imaging state of the imaging apparatus.
